(19) United States
(12) Patent Application Publication
(10) Pub. No.: US 2024/0241254 A1
(43) Pub. Date: Jul. 18, 2024

(54) DISTANCE MEASUREMENT DEVICE AND DISTANCE MEASUREMENT METHOD

(71) Applicant: SK hynix Inc., Icheon-si Gyeonggi-do (KR)

(72) Inventor: Yusuke Yata, Icheon-si Gyeonggi-do (KR)

(73) Assignee: SK hynix Inc., Icheon-si Gyeonggi-do (KR)

(21) Appl. No.: 18/324,007

(22) Filed: May 25, 2023

(30) Foreign Application Priority Data
Jan. 13, 2023 (KR) 10-2023-0005512

(51) Int. Cl. G01S 17/32; G01S 7/4911; G01S 7/4915

(52) U.S. Cl. CPC G01S 17/32; G01S 7/4911; G01S 7/4915

(57) ABSTRACT

Provided herein is a distance measurement device. The distance measurement device includes a controller configured to generate a modulated light control signal based on a first modulation frequency selected from among a plurality of modulation frequencies, a length per code determined based on the plurality of modulation frequencies, and number of codes in a pseudo noise code determining whether a pulse, included in each code and corresponding to the first modulation frequency, is inverted, a light source configured to output modulated light in response to the modulated light control signal, and a unit pixel including a first tap to which a first modulation voltage determined based on the modulated light control signal is applied and a second tap to which a second modulation voltage that is inverted from the first modulation voltage is applied.

### CROSS-REFERENCE TO RELATED APPLICATION

The present application claims priority under 35 U.S.C. § 119(a) to Korean patent application number 10-2023-0005512 filed on Jan. 13, 2023, in the Korean Intellectual Property Office, the entire disclosure of which is incorporated by reference herein.

### BACKGROUND

### 1. Technical Field

Various embodiments of the present disclosure generally relate to technology for measuring, and more particularly, to a distance measurement device and method for measuring a distance to an external object using a time-of-flight (TOF) method.

### 2. Related Art

Recently, in various fields such as security, medical appliances, vehicles, game consoles, virtual reality (VR)/augmented reality (AR), and mobile devices, a demand for image sensors for measuring a distance to an external object has increased. Distance measurement methods may include a triangulation method, a time-of-flight (hereinafter referred to as “TOF”) method, interferometry, etc. Among the methods, the TOF method is a method of calculating a distance by measuring the time-of-flight of light or a signal, that is, the time during which light or a signal is reflected and returned from an external object after the light or the signal is output, and is advantageous in that the range of utilization thereof is wide, a processing speed is high, and a cost benefit is high.

Among various TOF methods, an indirect TOF method may emit a modulated light wave (hereinafter referred to as ‘modulated light’) through a light source, wherein the modulated light may have a sine wave, a pulse train or another periodic waveform. A TOF sensor detects reflected light that is modulated light reflected from a surface in an observed scene. An electronic device measures a phase difference between the emitted modulated light and the received reflected light, and calculates a physical distance (or depth) between the TOF sensor and the external object in the scene.

### SUMMARY

An embodiment of the present disclosure may provide for a distance measurement device. The distance measurement device may include a controller configured to generate a modulated light control signal based on a first modulation frequency selected from among a plurality of modulation frequencies, a length per code determined based on the plurality of modulation frequencies, and number of codes in a pseudo noise code determining whether a pulse, included in each code and corresponding to the first modulation frequency, is inverted, a light source configured to output modulated light in response to the modulated light control signal, and a unit pixel including a first tap to which a first modulation voltage determined based on the modulated light control signal is applied and a second tap to which a second modulation voltage that is inverted from the first modulation voltage is applied.

An embodiment of the present disclosure may provide for a distance measurement device. The distance measurement device may include a controller configured to generate a first modulated light control signal based on a first modulation frequency selected from among a plurality of modulation frequencies, a length per code determined based on the plurality of modulation frequencies, and number of codes in a pseudo noise code determining whether a pulse, included in each code and corresponding to the first modulation frequency, is to be inverted, and to generate a second modulated light control signal based on a second modulation frequency selected from among the plurality of modulation frequencies, the length per code, and the number of codes, a first time-of-flight (TOF) module including both a first light source configured to output first modulated light in response to the first modulated light control signal, and a first unit pixel including taps to which modulation voltages related to the first modulated light control signal are respectively applied, and a second TOF module including both a second light source configured to output second modulated light in response to the second modulated light control signal, and a second unit pixel including taps to which modulation voltages related to the second modulated light control signal are respectively applied.

An embodiment of the present disclosure may provide for a distance measurement method. The distance measurement method may include determining a length per code based on a plurality of selectable modulation frequencies, selecting a first modulation frequency from among the plurality of modulation frequencies, determining number of codes in a pseudo noise code, generating a modulated light control signal which includes a pulse corresponding to the first modulation frequency in each code and determines whether the pulses are to be inverted depending on the pseudo noise code, based on the length per code, the first modulation frequency, and the number of codes, generating a first modulation voltage based on the modulated light control signal, and generating a second modulation voltage that is inverted from the first modulation voltage, outputting modulated light corresponding to the modulated light control signal through a light source, and calculating a distance to an external object based on reflected light that is modulated light reflected from the external object by respectively applying the first modulation voltage and the second modulation voltage to a first tap and a second tap included in a unit pixel.

### BRIEF DESCRIPTION OF THE DRAWINGS

FIG. 1 is a diagram schematically illustrating the configuration of a device according to an embodiment of the present disclosure.

FIG. 2 is a diagram schematically illustrating the configuration of a device including two TOF modules according to an embodiment of the present disclosure.

FIG. 3 is a diagram illustrating a unit pixel according to an embodiment of the present disclosure.

FIG. 4 is a diagram illustrating interference occurring when a distance to an external object is measured using two TOF modules.

FIG. 5 is a diagram illustrating an example of a modulated light control signal having inverted pulses depending on a pseudo noise code (pseudo random noise code) according to an embodiment of the present disclosure.

FIG. 6 is a diagram illustrating the effect of reducing interference between TOF modules when a pseudo noise code is used according to an embodiment of the present disclosure.

FIG. 7 is a diagram illustrating the effect of reducing interference between TOF modules when a pseudo noise code is used according to an embodiment of the present disclosure.

FIG. 8 is a diagram illustrating a principle based on which interference between TOF modules is reduced when frequency hopping is used according to an embodiment of the present disclosure.

FIG. 9 is a diagram illustrating the effect of reducing interference between TOF modules when frequency hopping is used according to an embodiment of the present disclosure.

FIG. 10 is a diagram illustrating an example of a first modulated light control signal and a second modulated light control signal when a pseudo noise code and frequency hopping are used according to an embodiment of the present disclosure.

FIG. 11 is a diagram illustrating the effect of reducing interference between TOF modules when a pseudo noise code and frequency hopping are used according to an embodiment of the present disclosure.

FIG. 12 is a flowchart illustrating a method of reducing interference between TOF modules according to an embodiment of the present disclosure.

### DETAILED DESCRIPTION

Specific structural or functional descriptions in the embodiments of the present disclosure introduced in this specification or application are provided as examples to describe embodiments according to the concept of the present disclosure. The embodiments according to the concept of the present disclosure may be practiced in various forms, and should not be construed as being limited to the embodiments described in the specification or application.

Various embodiments of the present disclosure will now be described in detail with reference to the accompanying drawings so that those skilled in the art can practice the technical spirit of the present disclosure.

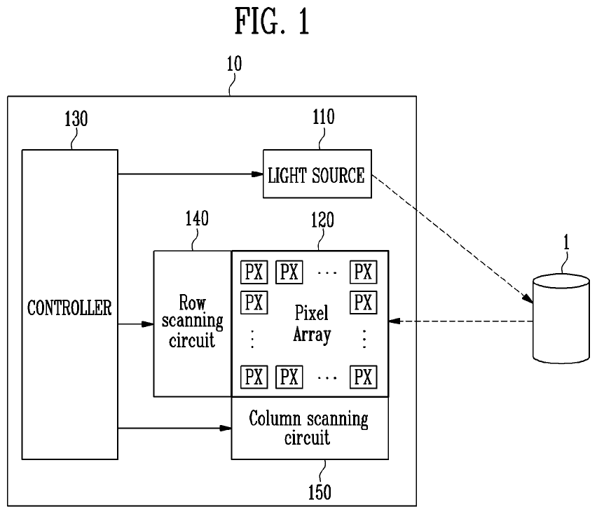

FIG. 1 is a diagram schematically illustrating the configuration of a device according to an embodiment of the present disclosure.

Referring to FIG. 1, a device 10 may include a light source 110, a pixel array 120, a controller 130, a row scanning circuit 140, and a column scanning circuit 150. The device 10 may measure a distance to an external object 1 or the depth of the external object 1 using a TOF method. The TOF method may be a scheme for emitting modulated light to the external object 1, detecting reflected light that is incident after being reflected from the external object 1, and indirectly measuring the distance between the device 10 and the external object 1 based on a phase difference between the modulated light and the reflected light. In the present disclosure, the device 10 may be referred to as a “distance measurement device.” Further, in the present disclosure, a method in which the device 10 measures the distance to the external object 1 may be referred to as a “distance measurement method.”

The light source 110 may emit light to the external object 1 in response to a modulated light control signal provided from the controller 130. The light source 110 may be a laser diode (LD) configured to emit light in a specific wavelength band (e.g., a near-infrared ray, an infrared ray, or visible light), a light emitting diode (LED), a near-infrared laser (NIR), a point light source, a monochromatic illumination source in which a white lamp is combined with a monochromator, or a combination of other laser light sources. For example, the light source 110 may emit infrared light (infrared ray) having a wavelength ranging from 800 nm to 1000 nm. The light emitted from the light source 110 may be modulated light that is modulated at a designated modulation frequency. It may be understood that the modulated light output from the light source 110 in the present disclosure is synchronized with the modulated light control signal received from the controller 130.

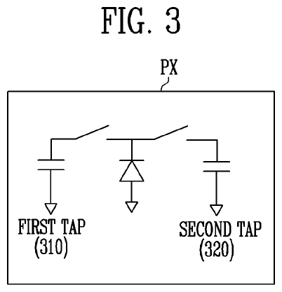

The pixel array 120 may include a plurality of unit pixels PX successively arranged in a two-dimensional (2D) matrix structure. For example, the pixel array 120 may include unit pixels PX successively arranged in a row direction and a column direction. Each unit pixel PX may be the minimum unit by which the same pattern is repeatedly arranged on the pixel array 120. Each unit pixel PX may include two taps. The internal structure of the unit pixel PX will be described in detail later with reference to FIG. 3.

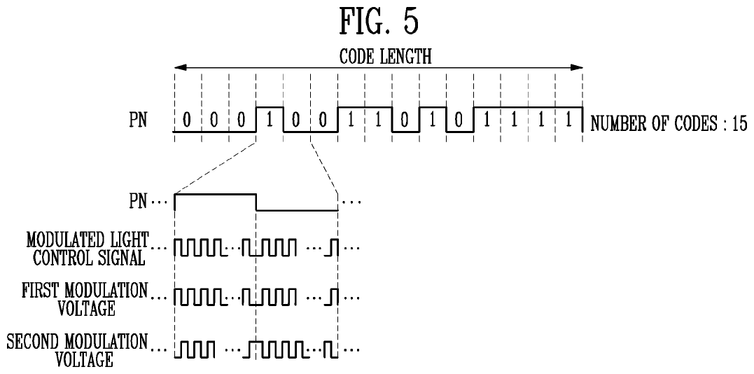

The controller 130 may generate the modulated light control signal and control the light source 110 to output the modulated light. Further, the controller 130 may apply a first modulation voltage and a second modulation voltage to each unit pixel PX using the row scanning circuit 140. The modulated light control signal, the first modulation voltage, and the second modulation voltage will be described in detail later with reference to FIGS. 5, 8, and 10.

The controller 130 may provide the modulated light control signal to the light source 110. The light source 110 may output modulated light corresponding to the modulated light control signal.

The controller 130 may apply the corresponding modulation voltage to each unit pixel PX through the row scanning circuit 140. The row scanning circuit 140 may output modulation voltages for generating a pixel current in the substrate of each unit pixel PX under the control of the controller 130. In an example, the controller 130 may generate a first modulation voltage and a second modulation voltage and provide the modulation voltages to the row scanning circuit 140, and the row scanning circuit 140 may apply the first modulation voltage and the second modulation voltage received from the controller 130 to the unit pixels PX. In an example, the controller 130 may provide a control signal related to the phase of the modulated light control signal to the row scanning circuit 140, and the row scanning circuit 140 may generate the first modulation voltage and the second modulation voltage and provide the modulation voltages to the unit pixels PX in response to the control signal.

The row scanning circuit 140 may generate a control signal for selecting and controlling at least one of a plurality of row lines in the pixel array 120. The control signal may include at least some of a reset signal for controlling a reset transistor, a transfer signal for controlling the transfer of photocharges accumulated in a detection area, and a select transistor for controlling a select transistor.

The controller 130 may control the column scanning circuit 150 to acquire pixel data from the pixel array 120. The column scanning circuit 150 may process pixel signals output from the pixel array 120 and then generate digital signal-format pixel data. The column scanning circuit 150 may also be referred to as a readout circuit.

The column scanning circuit 150 may perform correlated double sampling (CDS) on the pixel signals output from the pixel array 120. In an embodiment, the device 10 may reduce readout noise included in the pixel signals through CDS. Further, the column scanning circuit 150 may include an analog-to-digital converter (ADC) for converting output signals on which CDS is performed into digital signals. Furthermore, the column scanning circuit 150 may include a buffer circuit which stores the pixel data output from the ADC and outputs the pixel data to an external device.

The device 10 may further include a distance measurement module which calculates the distance to the external object 1 (or the depth of the external object 1) based on the pixel data acquired through the pixel array 120. For example, when the light source 110 emits modulated light, which is modulated at a preset frequency, to a scene captured by the device 10 and the device 10 detects reflected light (or incident light), which is reflected from the external object 1 in the scene, a time delay depending on the distance between the device 10 and the external object 1 is present between the modulated light and the reflected light. The distance measurement module may calculate the distance to the external object 1 based on a phase difference between the modulated light and the reflected light. The device 10 may generate a depth image including depth information for each unit pixel PX using the phase difference between the modulated light and the reflected light.

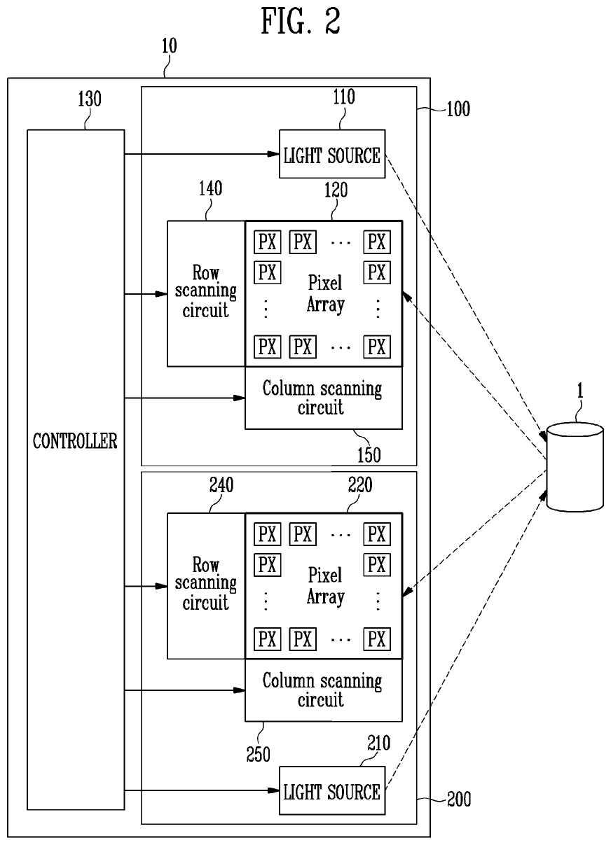

FIG. 2 is a diagram schematically illustrating the configuration of a device including two TOF modules according to an embodiment of the present disclosure. The device 10 of FIG. 2 may correspond to the device 10 of FIG. 1.

Referring to FIG. 2, the device 10 may include a first TOF module 100 and a second TOF module 200. The first TOF module 100 may include a light source 110, a pixel array 120, a row scanning circuit 140, and a column scanning circuit 150. The second TOF module 200 may include a light source 210, a pixel array 220, a row scanning circuit 240, and a column scanning circuit 250. Description of the light source 110, the pixel array 120, the row scanning circuit 140, and the column scanning circuit 150, described in FIG. 1, may also be applied to the light source 210, the pixel array 220, the row scanning circuit 240, and the column scanning circuit 250.

The first TOF module 100 may output first modulated light through the light source 110, and may receive first reflected light that is the first modulated light reflected from an external object 1 through the unit pixel PX of the pixel array 120. The second TOF module 200 may output second modulated light through the light source 210, and may receive second reflected light that is the second modulated light reflected from the external object 1 through the unit pixel PX of the pixel array 220. The controller 130 may individually control the first TOF module 100 and the second TOF module 200.

The device 10 including the two TOF modules (e.g., the first TOF module 100 and the second TOF module 200) may use at least one TOF module to measure the distance to the external object 1. For example, the device 10 may calculate the distance to the external object 1 using the first TOF module 100, calculate the distance to the external object 1 using the second TOF module 200, or calculate the distance to the external object 1 using both the first TOF module 100 and the second TOF module 200.

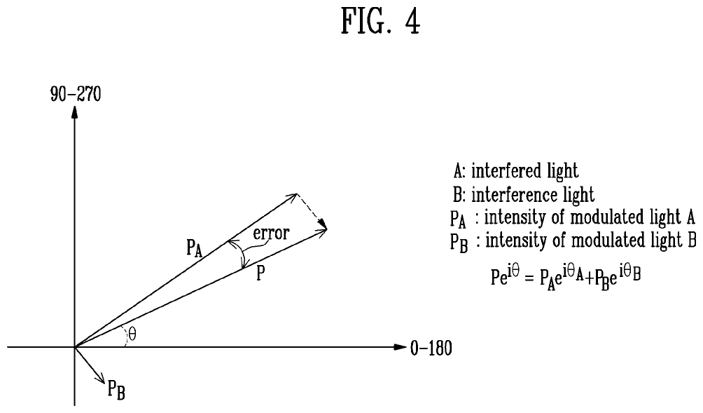

When the device 10 calculates the distance to the external object 1 using both the first TOF module 100 and the second TOF module 200, interference may occur due to the first modulated light output from the light source 110 and the second modulated light output from the light source 210. For example, not only the first reflected light but also the second reflected light may be incident on the pixel array 120 of the first TOF module 100. Therefore, an error corresponding to a charge amount depending on the second reflected light may be included in the distance to the external object 1 identified by the first TOF module 100. However, in accordance with the present disclosure, the error attributable to the interference may be reduced. Interference and error occurring between the two TOF modules will be described in detail later with reference to FIG. 4.

Although, in FIG. 2, the device 10 is illustrated and described as including the two TOF modules, that is, the first TOF module 100 and the second TOF module 200, this is only an example and the scope of the present disclosure is not limited thereto. For example, the device 10 may include three TOF modules, that is, the first TOF module 100, the second TOF module 200, and a third TOF module (not illustrated), or may include four or more TOF modules.

Furthermore, although, in FIG. 2, one controller 130 is illustrated as controlling both the first TOF module 100 and the second TOF module 200, this is only an example and the scope of the present disclosure is not limited thereto. Unlike the embodiment illustrated in FIG. 2, the controller 130 may be divided into controllers for respective TOF modules included in the device 10. For example, the controller 130 may include a first controller electrically connected to the first TOF module 100, and a second controller electrically connected to the second TOF module 200.

FIG. 3 is a diagram illustrating a unit pixel according to an embodiment of the present disclosure.

It may be understood that the unit pixel PX illustrated in FIG. 3 is a unit pixel PX included in the pixel array 120 of a first TOF module 100, or a unit pixel PX included in the pixel array 220 of a second TOF module 200.

Referring to FIG. 3, the unit pixel PX may include a first tap 310 and a second tap 320. In the present disclosure, the term “tap” refers to a node which generates a pixel current in a substrate as a modulation voltage is applied thereto, and may also be referred to as a demodulation node.

Each unit pixel PX may be a current-assisted photonic demodulator (CAPD) pixel, and may capture photocharges, generated in the substrate by incident light, using a potential difference in an electric field. For example, when incident light (e.g., reflected light that is modulated light reflected from an external object 1) is incident on the unit pixel PX), photocharges corresponding to the incident light may be generated through a photoelectric conversion area (e.g., a substrate, a photodiode, or the like). A first modulation voltage and a second modulation voltage may be respectively applied to the first tap 310 and the second tap 320 included in the unit pixel PX, and a pixel current may be generated in the unit pixel PX by the applied modulation voltages. The device 10 may capture photocharges, transferred by the pixel current, through the first tap 310 and the second tap 320.

The first modulation voltage applied to the first tap 310 and the second modulation voltage applied to the second tap 320 may have phases inverted from each other. For example, the second modulation voltage may have a phase difference of 180 degrees from the first modulation voltage. The first modulation voltage and the second modulation voltage will be described in detail later with reference to FIGS. 5, 8, and 10.

The device 10 may calculate the distance to the external object 1 based on pixel data acquired through the unit pixel PX. For example, the device 10 may measure the distance to the external object 1 based on charge amounts obtained through the first tap 310 and the second tap 320. The device 10 may calculate a distance D between the device 10 and the external object 1 using the following Equation 1. In Equation 1, when the first modulation voltage has a phase difference of 0 degrees from the modulated light and the second modulation voltage has a phase difference of 180 degrees from the modulated light, a charge amount obtained through the first tap 310 may be referred to as S0, and a charge amount obtained through the second tap 320 may be referred to as S180. Further, when the first modulation voltage has a phase difference of 90 degrees from the modulated light and the second modulation voltage has a phase difference of 270 degrees from the modulated light, a charge amount obtained through the first tap 310 may be referred to as S90, and a charge amount obtained through the second tap 320 may be referred to as S270. In equation 1, c may represent the speed of light, and f may represent the frequency.

$$D = \frac{c}{2} \frac{1}{2 π f} {tan}^{- 1} \frac{S 0 - S 180}{S 90 - S 270} \qquad ( 1 )$$

That is, the device 10 may calculate the distance D to the external object 1 based on the charge amounts obtained through the first tap 310 and the second tap 320 of the unit pixel PX. However, when the device 10 drives the first TOF module 100 and the second TOF module 200 together, both first modulated light from the light source 110 and second modulated light from the light source 210 may be incident on the unit pixel PX included in the pixel array 120 of the first TOF module 100. Therefore, charge amounts S0B, S180B, S90B, and S270B attributable to the second modulated light, as well as charge amounts S0A, S180A, S90A, and S270A attributable to the first modulated light, may be included in S0, S180, S90, and S270. Therefore, errors corresponding to the charge amounts S0B, S180B, S90B, and S270B attributable to the second modulated light may be included in the distance D measured through the unit pixel PX of the first TOF module 100. Similarly, errors corresponding to the charge amounts S0A, S180A, S90A, and S270A attributable to the first modulated light may be included in the distance D measured through the unit pixel PX of the second TOF module 200. However, in FIG. 4 and subsequent drawings, for convenience of description, description will be made based on the case where the first TOF module 100 is interfered with by the second TOF module 200.

FIG. 4 is a diagram illustrating interference occurring when a distance to an external object is measured using two TOF modules.

Referring to FIG. 4, A may denote first modulated light output from the light source 110 of the first TOF module 100, and B may denote second modulated light output from the light source 210 of the second TOF module 200. Because the description is made based on the case where the first TOF module 100 is interfered with by the second modulated light in FIG. 4, A may be referred to as interfered light, and B may be referred to as interference light. In description related to FIG. 4, the unit pixel PX, the first tap 310, and the second tap 320 may be components included in the first TOF module 100. Although, in FIG. 4, the description will be made based on the case where the first TOF module 100 is interfered with by the light source 210 of the second TOF module 200, the following description may also be applied to the opposite case whereby the second TOF module 200 is interfered with by the light source 110 of the first TOF module 100.

In FIG. 4, P may denote the intensity of light acquired through the first TOF module 100, P_{A} may denote the intensity of first modulated light output through the light source 110 of the first TOF module 100, among lights acquired through the first TOF module 100, and P_{B} may denote the intensity of second modulated light output through the light source 210 of the second TOF module 200, among the lights acquired through the first TOF module 100.

Referring to the graph of FIG. 4, the intensity P of light acquired through the first TOF module 100 may have a relationship of Equation 2 with P_{A}, and P_{B}. In equation 2, i may represent an imaginary number, that is, a number satisfying i²=−1.

$$P {e}^{i θ} = {P}_{A} {e}^{i {θ}_{A}} + {P}_{B} {e}^{i {θ}_{B}} \qquad ( 2 )$$

Referring to Equation 2, the intensity P of light acquired through the first TOF module 100 may include an error corresponding to P_{B}. That is, the first TOF module 100 may be interfered with by the intensity P_{B} of the second modulated light emitted from the second TOF module 200.

However, the device 100 according to an embodiment of the present disclosure may decrease the value of P_{B} to reduce the interference caused by the second TOF module 200. For example, the light intensity P may be calculated using the following Equation 3, wherein the device 100 may reduce the light intensity P_{B} by decreasing the difference between the charge amount attributable to the second modulated light, captured by the first tap 310, and the charge amount depending on the second modulated light, captured by the second tap 320.

$$P = \sqrt{{( S 0 - S 180 )}^{2} + {( S 90 - S 270 )}^{2}} \qquad ( 3 )$$

That is, to reduce P_{B}, the device 10 may enable the charge amount attributable to the second modulated light to be equally distributed to the first tap 310 and the second tap 320 while maintaining the intensity P_{A} of the first modulated light at a high value. For example, the device 10 may decrease the difference between S0B and S180B or the difference between S90B and S270B to reduce P_{B}. In order to equally distribute the charge amount attributable to the second modulated light to the first tap 310 and the second tap 320 included in the unit pixel PX of the first TOF module 100, the controller 130 may use the methods to be described below with reference to FIGS. 5 to 12.

FIG. 5 is a diagram illustrating an example of a modulated light control signal having inverted pulses depending on a pseudo noise code according to an embodiment of the present disclosure.

The device 10 (e.g., the controller 130) may generate a modulated light control signal using a pseudo-random noise code or pseudo noise code (hereinafter referred to as PN code). Further, the device 10 (e.g., the controller 130) may determine a first modulation voltage and a second modulation voltage using the PN code. For example, the controller 130 may use M-sequence PN codes configured such that, when PN codes are completely synchronized with each other, correlation characteristics are high, whereas when PN codes are asynchronous with each other, correlation characteristics are low. FIG. 5 may illustrate a modulation timing chart depending on a PN code.

Referring to FIG. 5, the controller 130 may use a PN code in which the number of codes is 15. The controller 130 may determine the number of codes N so that the number of codes is 2ⁿ−1 and n is a natural number equal to or greater than 2. For example, the number of codes N may be 3, 7, or 15.

The controller 130 may determine whether the modulated light control signal is to be inverted depending on the PN code. The controller 130 may determine whether the modulated light control signal is to be inverted depending on whether the PN code is 0 or 1. In an example, the controller 130 might not invert the modulated light control signal when the PN code is 1, and may invert the modulated light control signal when the PN code is 0. In an example, the controller 130 might not invert the modulated light control signal when the PN code is 0, and may invert the modulated light control signal when the PN code is 1. Referring to FIG. 5, in the case where the PN code is 1 and in the case where the PN code is 0, the modulated light control signal may have phases inverted from each other.

The controller 130 may generate a modulated light control signal including a pulse corresponding to a designated modulation frequency F for each code in the PN code. For example, the controller 130 may generate a modulated light control signal including M pulses for each code.

The device 10 may determine a first modulation voltage and a second modulation voltage based on the modulated light control signal. The device 10 may determine the first modulation voltage and the second modulation voltage to have phases inverted from each other. For example, the device 10 may determine the first modulation voltage to have a phase difference of any one of 0, 90, 180, or 270 degrees from the modulated light control signal, and may determine the second modulation voltage to have a phase inverted from that of the first modulation voltage. The first modulation voltage and the second modulation voltage having phases inverted from each other in the present disclosure may indicate that the second modulation voltage has an inactive voltage at a time at which the first modulation voltage has an active voltage and the second modulation voltage has an active voltage at a time at which the first modulation voltage has an inactive voltage.

Referring to FIG. 5, a code length may be determined according to the number of codes in the PN code, the number of pulses M included in each code, and a modulation frequency F. The code length may be determined according to N×M/F. For example, when the code length is 15, the number of pulses in each code is 30, and the modulation frequency is 40 MHZ, the code length may be 11.25 μs. The device 10 may determine the exposure time of the unit pixel PX based on the code length. For example, the device 10 may determine the exposure time of the unit pixel PX to be equal to or greater than the code length. That is, the interference by another TOF module may be reduced only when the unit pixel PX is exposed for at least a period of time equal to the code length.

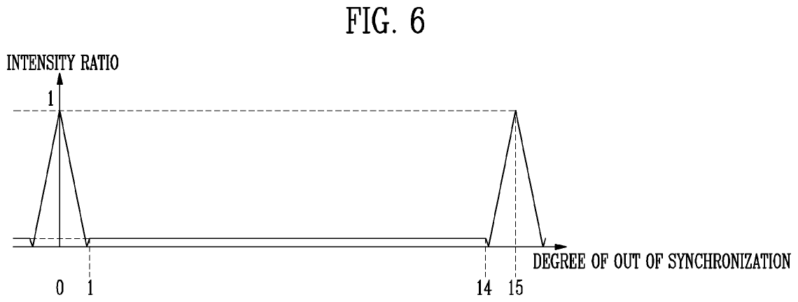

FIG. 6 is a diagram illustrating the effect of reducing interference between TOF modules when a pseudo noise code is used according to an embodiment of the present disclosure.

FIG. 6 is a graph illustrating the illustrating the effect of reducing interference between different TOF modules in response to a modulated light control signal determined based on a PN code having 15 codes. In the graph of FIG. 6, an x axis may indicate the degree to which first modulated light and second modulated light are asynchronous with each other. In the graph of FIG. 6, a y axis may indicate the ratio of the intensity P_{B} of second modulated light to the intensity P_{A} of first modulated light, among lights acquired through the first TOF module 100. In description related to FIG. 6, it may be understood that the first modulated light is synchronized with a first modulated light control signal provided to the light source 110 of the first TOF module 100 and the second modulated light is synchronized with a second modulated light control signal provided to the light source 210 of the second TOF module 200. Therefore, in description related to FIG. 6, it may be understood that description of the first modulated light and the second modulated light is that of the first modulated light control signal and the second modulated light control signal.

Referring to FIG. 6, when first modulated light is synchronized with second modulated light (e.g., when the degree to which the first modulated light and the second modulated light are out of synchronization is 0 and 15), the intensity ratio of P_{B} to P_{A} may be 1, and the intensity P_{B} of the second modulated light may be the maximum. As the first modulated light and the second modulated light become out of synchronization, the intensity ratio may be reduced. Further, when the first modulated light and the second modulated light are out of synchronization by one code, the intensity ratio may be reduced to 1/15. Therefore, when the first modulated light and the second modulated light are unsynchronized with each other, the degree to which the first TOF module 100 is interfered with by the second modulated light of the second TOF module 200 may be reduced to 1/15.

Because the device 10 separately controls the first TOF module 100 and the second TOF module 200, the light source 110 of the first TOF module 100 and the light source 210 of the second TOF module 200 may be asynchronously driven. That is, because the first modulated light and the second modulated light are asynchronous with each other in a normal situation, the device 10 may reduce interference by another TOF module to 1/N (where N is the number of codes) by means of the use of the PN code.

As the device 10 determines the number of codes in the PN code to be a value greater than 15, the probability of the first TOF module 100 and the second TOF module 200 interfering with each other, that is, the degree of interference light attributable to another TOF module may be further reduced.

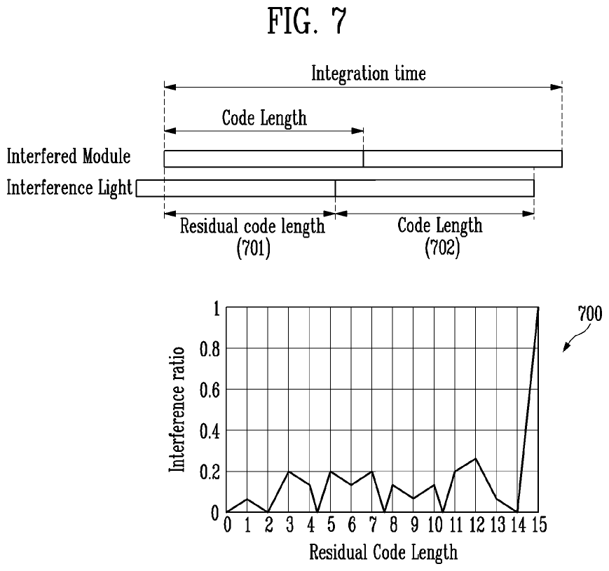

FIG. 7 is a diagram illustrating the effect of reducing interference between TOF modules when a pseudo noise code is used according to an embodiment of the present disclosure.

In relation to FIG. 7, description will be made on the assumption that an interfered module is a first TOF module 100 and interference light is second modulated light from a second TOF module 200.

The device 10 according to an embodiment may obtain charge amounts corresponding to incident light through the unit pixels PX of the pixel array 120 during an integration time corresponding to twice a code length. Referring to FIG. 7, the device 10 asynchronously controls the first TOF module 100 and the second TOF module 200, and thus a part of the time during which the second modulated light is output might not overlap the integration time during which the first TOF module 100 is driven. For example, the unit pixel PX of the first TOF module 100 might not receive a part of second modulated light output from the light source 210 of the second TOF module 200.

Although the interference strength of second modulated light corresponding to a code length 702 may be reduced to 1/N on the unit pixel PX of the first TOF module 100, the second modulated light corresponding to a residual code length 701 may have an interference strength higher than 1/N without being completely cancelled in the unit pixel PX of the first TOF module 100.

A graph 700 may indicate an interference strength ratio (interference ratio) depending on the residual code length 701. Referring to the graph 700, in the case where the residual code length 701 is equal to the code length 702 (e.g., 15), the interference strength ratio may be 1, and in the remaining cases, the strength of interference with the first TOF module 100 by the second modulated light may be reduced to an average of 10%.

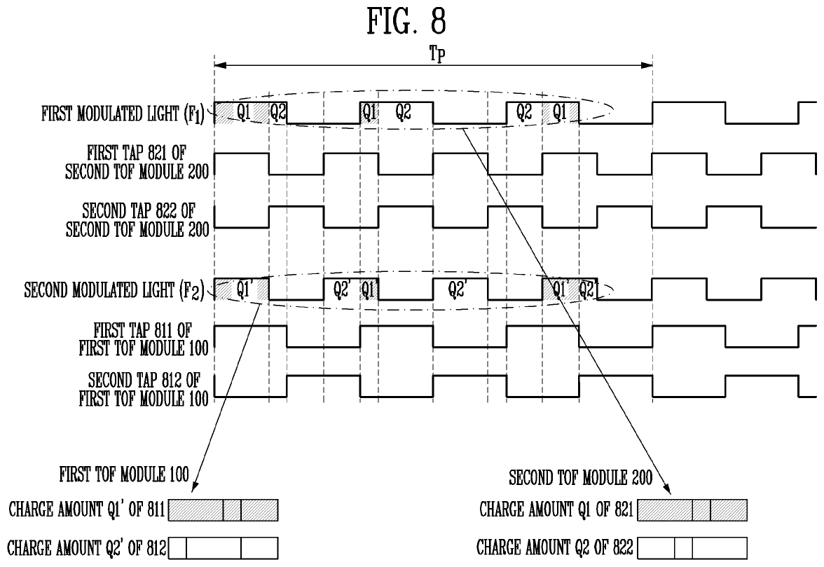

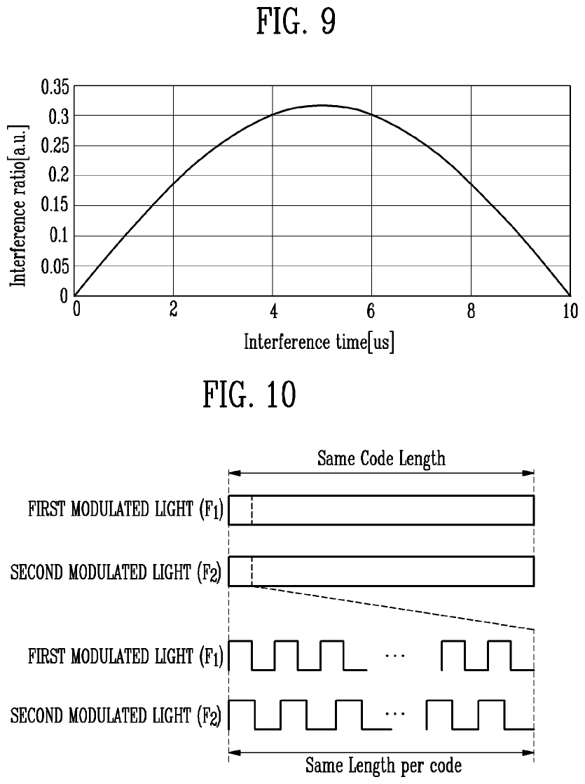

Referring to description made in relation to FIGS. 5 to 7, the device 10 may reduce interference occurring between the first TOF module 100 and the second TOF module 200 by generating a modulated light control signal having a pulse, the inverting or non-inverting of which is determined depending on the PN code. Referring to the graph of FIG. 6 and the graph 700 of FIG. 7, interference strength might not be sufficiently reduced when the first modulated light is synchronized with the second modulated light. Therefore, the device 10 may further decrease interference by mutual modulated lights by using frequency hopping, which will be described below with reference to FIGS. 8 and 9, together with the PN code.

FIG. 8 is a diagram illustrating a principle based on which interference between TOF modules is reduced when frequency hopping is used according to an embodiment of the present disclosure.

The device 10 (e.g., the controller 130) may generate a modulated light control signal using frequency hopping. The device 10 may select a first modulation frequency F₁ and a second modulation frequency F₂ from among a plurality of modulation frequencies, and may generate a first modulated light control signal based on the first modulation frequency F₁, and generate a second modulated light control signal based on the second modulation frequency F₂. For example, the device 10 may randomly set a modulation frequency for each frame acquired through the unit pixel PX of the first TOF module 100 or the unit pixel PX of the second TOF module 200.

In FIG. 8, the principle based on which interference between the first TOF module 100 and the second TOF module 200 is reduced when the first modulation frequency F₁ and the second modulation frequency F₂ are different from each other will be described. For example, in FIG. 8, description will be made on the assumption that F₁:F₂=4:3 is satisfied.

Referring to description made with reference to FIG. 4, interference between the first TOF module 100 and the second TOF module 200 may occur due to second modulated light incident on the first TOF module 100 or first modulated light incident on the second TOF module 200. Therefore, the device 10 allows the second modulated light incident on the first TOF module 100 to be equally distributed to a first tap 811 and a second tap 812 of the first TOF module 100 or allows the first modulated light incident on the second TOF module 200 to be equally distributed to a first tap 821 and a second tap 822 of the second TOF module 200, thus decreasing interference between the TOF modules.

Referring to FIG. 8, the device 10 may output first modulated light having a phase corresponding to the first modulation frequency F₁. The device 10 may individually apply a modulation voltage corresponding to the second modulation frequency F₂ to both the first tap 821 and the second tap 822 of the second TOF module 200. The first tap 821 of the second TOF module 200 may obtain a charge amount Q1 corresponding to the first modulated light and the second tap 822 of the second TOF module 200 may obtain a charge amount Q2 corresponding to the first modulated light.

Similarly, the device 10 may output second modulated light having a phase corresponding to the second modulation frequency F₂. The device 10 may individually apply a modulation voltage corresponding to the first modulation frequency F₁ to both the first tap 811 and the second tap 812 of the first TOF module 100. The first tap 811 of the first TOF module 100 may obtain a charge amount Q1′ corresponding to the second modulated light and the second tap 812 of the first TOF module 100 may obtain a charge amount Q2′ corresponding to the second modulated light.

Referring to FIG. 8, during a specific period T_{P}, the charge amounts Q1 and Q2 respectively obtained by the first tap 821 and the second tap 822 of the second TOF module 200 based on the first modulated light may have the same value. Further, during the specific period T_{P}, the charge amounts Q1′ and Q2′ respectively obtained by the first tap 811 and the second tap 812 of the first TOF module 100 based on the second modulated light may have the same value.

Therefore, in the case where the device 10 uses frequency hopping, when the specific period T_{P} is used, no interference or negligibly small interference may occur between the first TOF module 100 and the second TOF module 200. For example, the device 10 may set the exposure time of the unit pixel PX to a value corresponding to a multiple of T_{P}. Furthermore, the device 10 may set the minimum exposure time of the unit pixel PX to T_{P}. The specific period T_{P} during which interference between the TOF modules is cancelled may be calculated using the following Equation 4. The device 10 may cancel the interference between the TOF modules using F₁, F₂, and T_{P} satisfying Equation 4.

$$\frac{1}{{F}_{1}} \cdot X = \frac{1}{{F}_{2}} \cdot Y = {T}_{p} ( where X and Y are integers ) \qquad ( 4 )$$

For example, the device 10 may randomly set F₁ and F₂ from among a plurality of modulation frequencies present at intervals of 0.1 MHZ, such as 40, 40.1, 40.2, and 40.3 MHz. The device 10 may set T_{P}, satisfying Equation 4, to 10 us based on the plurality of modulation frequencies present at intervals of 0.1 MHz.

The device 10 may reduce interference between the first TOF module 100 and the second TOF module 200 by randomly selecting F₁ and F₂ from among a plurality of previously designated modulation frequencies. Furthermore, as the number of the plurality of selectable modulation frequencies is larger, interference between TOF modules may be further decreased.

FIG. 9 is a diagram illustrating the effect of reducing interference between TOF modules when frequency hopping is used according to an embodiment of the present disclosure.

The graph of FIG. 9 may illustrate the light intensity ratio of interference light (interference ratio) depending on the time at which interference light is incident (interference time). For example, description is made based on the case where the unit pixel PX of the first TOF module 100 is interfered with by the second modulated light of the second TOF module 200. That is, the x axis of the graph in FIG. 9 may denote the time at which second modulated light is incident on the first TOF module 100, and the y axis thereof may denote the intensity ratio of the second modulated light to first modulated light incident on the first TOF module 100.

Referring to FIG. 9, the intensity of the second modulated light to the first modulated light may be a maximum of 31%. That is, the device 10 may decrease interference between the TOF modules to 31% or less by utilizing frequency hopping.

FIG. 10 is a diagram illustrating an example of a first modulated light control signal and a second modulated light control signal when a pseudo noise code and frequency hopping are used according to an embodiment of the present disclosure.

The device 10, in an embodiment, may reduce interference between TOF modules using together the PN code described with reference to FIGS. 5 to 7 and the frequency hopping described in FIGS. 9 and 10. Although the device 10, in an embodiment, may reduce interference between TOF modules by utilizing the PN code, such interference might not be sufficiently cancelled when the first modulated light is synchronized with the second modulated light. Further, although the device 10, in an embodiment, may reduce interference between TOF modules by utilizing frequency hopping, there is a limitation in the number of selectable modulation frequencies, and thus interference among three or more TOF modules might not be sufficiently cancelled. However, the device 10 according to an embodiment of the present disclosure may decrease the strength of interference that may occur between TOF modules or reduce the probability of interference occurring between the TOF modules, by using the PN code and frequency hopping together.

Referring to FIG. 10, the device 10 may select a first modulation frequency F₁ and a second modulation frequency F₂ from among a plurality of selectable modulation frequencies. The device 10 may determine T_{P} satisfying Equation 4 based on the plurality of selectable modulation frequencies. T_{P} may be referred to as a length per code in FIG. 10. The length per code may be determined such that, even though F₁ and F₂ are randomly selected from among the plurality of modulation frequencies, the length per code remains uniform. Further, the device 10 may determine the length per code so that the length per code of first modulated light (or a first modulated light control signal) and the length per code of second modulated light (or a second modulated light control signal) have the same value.

In FIG. 10, a code length may denote a value obtained by multiplying the number of codes (e.g., 15) by the length per code. For example, when the device 10 selects F₁ and F₂ from among a plurality of modulation frequencies present at intervals of 1 MHz such as 40, 41, and 42, the length per code may be 1 μs. Here, when the number of codes is 15, the code length may be 15 μs.

A detailed example in which the length per code is determined depending on the plurality of selectable modulation frequencies will be described as follows.

The plurality of selectable modulation frequencies (or sub-hopping frequencies) may be set in various manners by a designer of the device 100. For example, the plurality of modulation frequencies may include 36, 38, 40, and 42 present at intervals of 2 MHZ, or may include 39.7, 39.8, 39.9, 40, and 40.1 present at intervals of 0.1 MHZ. In an example, the plurality of modulation frequencies may include 39.8, 39.9, 42, 42.2, 44, etc. present at irregular intervals.

The device 10 may determine the length per code based on the plurality of modulation frequencies. For example, it is assumed that the plurality of selectable frequencies are 40, 40.1, 40.21, 40.3, and 40.54 MHz. The device 10 may calculate difference values between the plurality of modulation frequencies. When the plurality of modulation frequencies are 40, 40.1, 40.21, 40.3, and 40.54 MHZ, the difference values between the modulation frequencies may be 0.1, 0.11, 0.09, and 0.24 MHz. The device 10 may calculate the greatest common factor of the difference values between the modulation frequencies. When the difference values between the modulation frequencies are 0.1, 0.11, 0.09, and 0.24 MHz, the greatest common factor may be 0.01 MHz. When the plurality of modulation frequencies are divided by the greatest common factor, the number of pulses included in each code may be obtained. When the modulation frequency is 40 MHZ, the number of pulses included in each code may be 40/0.01=4000. Therefore, the length per code may be 4000/40 MHZ=100 us. Similarly, when the modulation frequency is 40.1 MHz, the number of pulses included in each code may be 40.1/0.01=4010. Therefore, the length per code may be 4010/40.1 MHz=100 μs. That is, the length per code may be uniform at 100 us regardless of the selected modulation frequency.

In an example, it is assumed that the plurality of selectable frequencies are 20.3, 20.5, 20.9, and 23.1 MHZ. The difference values between the plurality of modulation frequencies may be 0.2, 0.4, and 2.2 MHz, and the greatest common factor thereof may be 0.2. However, when the number of pulses included in each code is calculated, the number of pulses per code may be 20.3 MHz/0.2 MHZ=101.5 in the case where the modulation frequency is 20.3 MHZ. Further, when the modulation frequency is 20.5 MHZ, the number of pulses per code may be 20.5 MHz/0.2 MHz=102.5. That is, the number of pulses per code may include a value below the decimal point. When the number of pulses per code includes a value below the decimal point, the device 10 may perform the same calculation using an additional common factor other than the greatest common factor. Further, when the modulation frequency is 20.3 MHZ, the number of pulses per code may be 20.3 MHz/0.1 MHZ=203. Furthermore, when the modulation frequency is 20.5 MHZ, the number of pulses per code may be 20.5 MHz/0.1 MHZ=205. Therefore, the length per code may be 203/20.3 MHZ=10 μs.

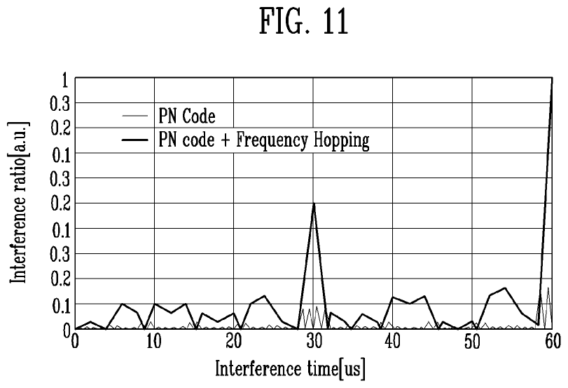

FIG. 11 is a diagram illustrating the effect of reducing interference between TOF modules when a pseudo noise code and frequency hopping are used according to an embodiment of the present disclosure.

The graph of FIG. 11 may indicate the degree to which interference decreases in the case where a PN code and frequency hopping are used together compared to the case where the device 10 uses the PN code and does not use frequency hopping. The x axis of the graph in FIG. 11 may denote the time at which second modulated light that is interference light is incident on the first TOF module 100, and the y axis thereof may denote the ratio of the intensity of the second modulated light to the intensity of first modulated light incident on the first TOF module 100.

Referring to the graph of FIG. 11, when the first modulated light of the first TOF module 100 is synchronized with the second modulated light of the second TOF module 200, high interference strength is obtained when only a PN code is applied, but the interference strength may be reduced to 1/5 or less when the PN code and frequency hopping are applied together, as in the case of the present disclosure. Furthermore, even though the interference strength is low when only a PN code is applied, the interference strength may be further decreased when the PN code and the frequency hopping are applied together.

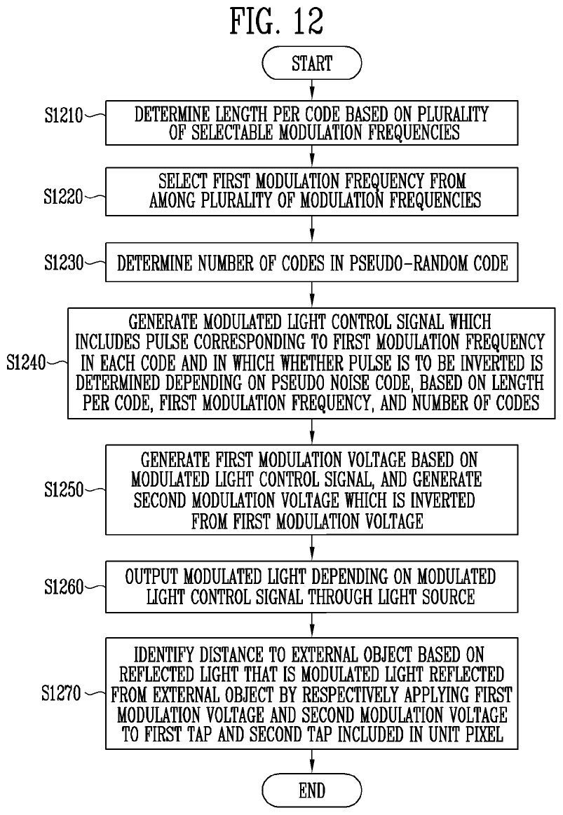

FIG. 12 is a flowchart illustrating a method of reducing interference between TOF modules according to an embodiment of the present disclosure. It may be understood that steps to be described in FIG. 12 are performed by the device 10 or the controller 130 included in the electronic device 10.

At step S1210, the device 10 (e.g., the controller 130) may determine a length per code based on a plurality of selectable modulation frequencies. As to a method of determining the length per code based on the plurality of modulation frequencies, description made in relation to FIG. 10 may be referred to. Because the device 10 determines the length per code based on the plurality of selectable modulation frequencies, the length per code may have a uniform value regardless of the modulation frequency selected at step S1220.

At step S1220, the device 10 (e.g., the controller 130) may select a first modulation frequency from among the plurality of modulation frequencies. The device 10 may randomly select a modulation frequency for each frame acquired through a unit pixel PX. For example, the controller 300 may acquire a first frame through the unit pixel PX based on the first modulation frequency (e.g., 40 MHZ) selected from among the plurality of modulation frequencies, and may acquire a second frame subsequent to the first frame through the unit pixel PX based on a second modulation frequency (e.g., 40.1 MHZ) selected from among the plurality of modulation frequencies.

At step S1230, the device 10 (e.g., the controller 130) may determine the number of codes in a pseudo noise code (PN code). The device 10 may determine the number of codes so that the number of codes is 2ⁿ−1 and n is a natural number equal to or greater than 2. The number of codes may be determined within a range that can be implemented by a designer or based on requirement of an application in which TOF modules are used. For example, when the distance desired to be measured by the device 10 through TOF modules (e.g., 100 and 200) is 6 m, the device 10 may use a modulation frequency of 25 MHz or less having a maximum measurable distance of 6 m. The number of codes may be determined in consideration of power and pixel saturation. For example, the device 10 may determine the maximum exposure time of the unit pixel PX so that the unit pixel PX is not saturated. When the maximum exposure time is 100 us and the length per code is 10 μs, the number of codes needs to be 10 or less and is limited to 2ⁿ−1, and thus the device 10 may determine the number of codes to be 3 or 7. As the number of PN codes is larger, correlation characteristics may be reduced, whereby the device 10 may determine the number of codes to be 7, and may determine the code length to be 10 μs×7=70 μs.

At step S1240, the device 10 (e.g., the controller 130) may generate a modulated light control signal which includes a pulse corresponding to the first modulation frequency in each code and in which whether the pulse is to be inverted is determined depending on the pseudo noise code, based on the length per code, the first modulation frequency, and the number of codes. For example, the device 10 may determine whether the pulse is to be inverted depending on whether the PN code is 0 or 1.

At step S1250, the device 10 (e.g., the controller 130) may generate a first modulation voltage based on the modulated light control signal, and may generate a second modulation voltage that is inverted from the first modulation voltage. The controller 130 may determine the first modulation voltage so that the first modulation voltage has a phase difference of any one of 0, 90, 180, or 270 degrees from the modulated light control signal.

At step S1260, the device 10 (e.g., the controller 130) may output modulated light depending on the modulated light control signal through the light source 110.

At step S1270, the device 10 (e.g., the controller 130) may calculate the distance to an external object 1 based on reflected light that is modulated light reflected from the external object 1 by respectively applying the first modulation voltage and the second modulation voltage to a first tap 310 and a second tap 320 included in the unit pixel PX.

According to an embodiment of the present disclosure, interference by modulated lights of two or more TOF modules may be reduced even when a distance to an external object is measured using the two or more TOF modules together, thus improving the accuracy of distances measured by the TOF modules.

What is claimed is:

1. A distance measurement device, comprising:
a controller configured to generate a modulated light control signal based on a first modulation frequency selected from among a plurality of modulation frequencies, a length per code determined based on the plurality of modulation frequencies, and number of codes in a pseudo noise code determining whether a pulse, included in each code and corresponding to the first modulation frequency, is inverted;
a light source configured to output modulated light in response to the modulated light control signal; and
a unit pixel including a first tap to which a first modulation voltage determined based on the modulated light control signal is applied and a second tap to which a second modulation voltage that is inverted from the first modulation voltage is applied.

2. The distance measurement device according to claim 1, wherein the length per code has a uniform value regardless of modulation frequency selected from among the plurality of modulation frequencies.

3. The distance measurement device according to claim 1, wherein the controller determines whether the pulse is to be inverted depending on whether the code is 0 or 1.

4. The distance measurement device according to claim 1, wherein the number of codes is 2ⁿ−1, where n is a natural number equal to or greater than 2.

5. The distance measurement device according to claim 1, wherein the controller determines an exposure time of the unit pixel based on the length per code and the number of codes.

6. The distance measurement device according to claim 1, wherein the controller is configured to:
acquire a first frame through the unit pixel based on the first modulation frequency selected from among the plurality of modulation frequencies, and
acquire a second frame subsequent to the first frame through the unit pixel based on a second modulation frequency selected from among the plurality of modulation frequencies.

7. The distance measurement device according to claim 1, wherein the first modulation voltage is determined to have a phase difference of any one of 0, 90, 180, or 270 degrees from the modulated light control signal.

8. The distance measurement device according to claim 1, wherein the unit pixel is configured to:
generate photocharges based on reflected light that is modulated light reflected from an external object,
generate a pixel current in the unit pixel depending on the first modulation voltage and the second modulation voltage that are applied to the first tap and the second tap, and
capture the photocharges transferred depending on the pixel current through the first tap and the second tap.

9. The distance measurement device according to claim 8, further comprising:
a readout circuit configured to acquire pixel data corresponding to the captured photocharges from the first tap and the second tap; and
a distance measurement module configured to calculate a distance to the external object based on the pixel data.

10. A distance measurement device, comprising:
a controller configured to generate a first modulated light control signal based on a first modulation frequency selected from among a plurality of modulation frequencies, a length per code determined based on the plurality of modulation frequencies, and number of codes in a pseudo noise code determining whether a pulse, included in each code and corresponding to the first modulation frequency, is inverted, and to generate a second modulated light control signal based on a second modulation frequency selected from among the plurality of modulation frequencies, the length per code, and the number of codes;
a first time-of-flight (TOF) module including both a first light source configured to output first modulated light in response to the first modulated light control signal, and a first unit pixel including taps to which modulation voltages related to the first modulated light control signal are respectively applied; and
a second TOF module including both a second light source configured to output second modulated light in response to the second modulated light control signal, and a second unit pixel including taps to which modulation voltages related to the second modulated light control signal are respectively applied.

11. The distance measurement device according to claim 10, wherein the controller asynchronously controls the first light source and the second light source.

12. The distance measurement device according to claim 10, wherein the length per code has an identical value for the first modulated light control signal and the second modulated light control signal.

13. A distance measurement method, comprising:
determining a length per code based on a plurality of selectable modulation frequencies;
selecting a first modulation frequency from among the plurality of modulation frequencies;
determining number of codes in a pseudo noise code;
generating a modulated light control signal which includes a pulse corresponding to the first modulation frequency in each code and determines whether the pulses are to be inverted depending on the pseudo noise code, based on the length per code, the first modulation frequency, and the number of codes;
generating a first modulation voltage based on the modulated light control signal, and generating a second modulation voltage that is inverted from the first modulation voltage;
outputting modulated light corresponding to the modulated light control signal through a light source; and
calculating a distance to an external object based on reflected light that is modulated light reflected from the external object by respectively applying the first modulation voltage and the second modulation voltage to a first tap and a second tap included in a unit pixel.

14. The distance measurement method according to claim 13, wherein determining the length per code comprises:
determining the length per code to have a uniform value regardless of the first modulation frequency selected from among the plurality of modulation frequencies.

15. The distance measurement method according to claim 13, wherein selecting the first modulation frequency comprises:
randomly selecting the first modulation frequency that is any one modulation frequency from among the plurality of modulation frequencies, for each frame acquired through the unit pixel.

16. The distance measurement method according to claim 13, wherein generating the modulated light control signal comprises:
determining whether the pulse is to be Inverted depending on whether the code is 0 or 1.
